(19) United States
(12) Patent Application Publication
(10) Pub. No.: US 2026/0227872 A1
(43) Pub. Date: Aug. 6, 2026

(54) INPUT DEVICE HAVING INTEGRATED ELECTROMAGNETIC RESONANCE (EMR) STYLUS AND CAPACITIVE TOUCH SENSING

(71) Applicant: Synaptics Incorporated, San Jose, CA (US)

(72) Inventors: Guozhong Shen, Fremont, CA (US); Chieh-Feng Tu, Shanghai (CN)

(21) Appl. No.: 19/465,728

(22) Filed: Jan. 30, 2026

Related U.S. Application Data
(60) Provisional application No. 63/752,270, filed on Jan. 31, 2025.

(51) Int. Cl. G06F 3/041; G06F 3/044; G06F 3/046

(52) U.S. Cl. CPC G06F 3/04162; G06F 3/0441; G06F 3/0446; G06F 3/046; G06F 3/0448; G06F 2203/04106; G06F 2203/04107; G06F 2203/04112; G06F 2203/04114

(57) ABSTRACT

A sensor apparatus includes a plurality of electrodes disposed in a single integrated layer. The plurality of electrodes includes: a first set of electrodes corresponding to a first direction, wherein each of the first set of electrodes comprises a trunk and a plurality of branches protruding from the trunk; and a second set of electrodes corresponding to a second direction, wherein each of the second set of electrodes is configured to form a current loop. The plurality of electrodes are configured to be operable in both a first sensing mode and a second sensing mode, wherein in the first sensing mode, the second set of electrodes are operated to provide respective current loops.

### CROSS-REFERENCE TO RELATED APPLICATIONS

This patent application claims the benefit of U.S. Provisional Patent Application No. 63/752,270, filed January 31, 2025, which is incorporated by reference herein in its entirety.

### TECHNICAL FIELD

The present disclosure relates generally to input devices, and more specifically, to integration of electromagnetic resonance (EMR) stylus and capacitive touch sensing.

### BACKGROUND

Input devices, including touch sensor devices and fingerprint sensor devices, are widely used in a variety of electronic systems. Touch sensor devices typically include a sensing region, often demarked by a surface, in which the touch sensor device determines the presence, location and/or motion of one or more input objects.

Touch sensor devices and fingerprint sensor devices may be used to provide interfaces for an electronic system. For example, touch sensor devices and fingerprint sensor devices are often used as input devices for larger computing systems (such as opaque touchpads and fingerprint readers integrated in, or peripheral to, notebook or desktop computers). Touch sensor devices are also often used in smaller computing systems (such as touchscreens integrated in smartphones).

Such electronic systems may additionally include a stylus or pen for interacting with the electronic system. As one of various examples, the stylus may utilize electromagnetic resonance (EMR) technology, and the electronic system may include a touchscreen. A coil inside the stylus may resonate in response to a magnetic field produced by the touchscreen.

Conventionally, detection of an EMR stylus requires additional physical layers in the touchscreen, including but not limited to adding a mesh or grid of coils capable of generating an oscillating magnetic field. The mesh or grid of coils increases overall cost and size of the electronic system.

### SUMMARY

This summary is provided to introduce a selection of concepts in a simplified form that are further described below. This summary is not intended to necessarily identify key features or essential features of the present disclosure, nor is it intended to limit the scope of the claimed subject matter.

In an exemplary embodiment, the present application provides a system. The system includes: a plurality of electrodes disposed in a single integrated layer, including a first set of electrodes corresponding to a first direction and a second set of electrodes corresponding to a second direction, wherein each of the first set of electrodes comprises a trunk and a plurality of branches protruding from the trunk, and wherein each of the second set of electrodes is configured to form a current loop; and a processing system configured to: operate the plurality of electrodes in a first sensing mode, wherein the first sensing mode, the second set of electrodes are operated to provide respective current loops, and wherein in the first sensing mode, the processing system is configured to determine a location of a stylus in a sensing region corresponding to the plurality of electrodes; and operate the plurality of electrodes in a second sensing mode, wherein in the second sensing mode, the processing system is configured to determine a location of an input object in the sensing region.

In a further exemplary embodiment, in the second sensing mode, the first set of electrodes is operable as transmitter electrodes and the second set of electrodes is operable as receiver electrodes for two-dimensional capacitive touch sensing; and in the second sensing mode, the first set of electrodes is operable as receiver electrodes and the second set of electrodes is operable as transmitter electrodes for two-dimensional capacitive touch sensing.

In a further exemplary embodiment, in the second sensing mode, respective electrodes of the first set of electrodes are operable as transmitter electrodes and other respective electrodes of the first set of electrodes are operable as receiver electrodes for one-dimensional parallel transcapacitive touch sensing corresponding to the first direction; and in the second sensing mode, respective electrodes of the second set of electrodes are operable as transmitter electrodes and other respective electrodes of the second set of electrodes are operable as receiver electrodes for one-dimensional parallel transcapacitive touch sensing corresponding to the second direction.

In a further exemplary embodiment, the plurality of branches includes a subset of branches which have sub-branches protruding from respective branches of the subset of branches.

In a further exemplary embodiment, the plurality of branches include one or more branches having a sawtooth shape.

In a further exemplary embodiment, the second set of electrodes are shaped so as to surround peripheries of respective electrodes of the first set of electrodes; and the first and second sets of electrodes are electrically separated from each other.

In a further exemplary embodiment, each of the second set of electrodes has a first connection to the processing system, a first half, a second half, a second connection to the processing system; the first and second connections to the processing system for a respective electrode of the second set of electrodes are disposed on a first side of the respective electrode; the first half and the second half are electrically connected to each other on a second side of the respective electrode opposite the first side; and the current loop traverses the first connection to the processing system, the first half, the second half, and the second connection to the processing system in sequence.

In a further exemplary embodiment, a portion of a respective electrode of the second set of electrodes corresponding to a respective sensing pixel comprises four parts, wherein two of the four parts are part of the first half and are connected to each other via a first jumper that bypasses a respective first electrode, and the other two of the four parts are part of the second half and connected to each other via a second jumper that bypasses the respective first electrode.

In a further exemplary embodiment, the single integrated layer is a metal mesh layer, and each of the plurality of electrodes is comprised of metal mesh.

In a further exemplary embodiment, the first sensing mode is a stylus sensing mode, and the stylus is configured to resonate electromagnetically; and the second sensing mode is a capacitive touch sensing mode.

In another exemplary embodiment, the present application provides a sensor apparatus. The sensor apparatus includes: a plurality of electrodes disposed in a single integrated layer. The plurality of electrodes includes: a first set of electrodes corresponding to a first direction, wherein each of the first set of electrodes comprises a trunk and a plurality of branches protruding from the trunk; and a second set of electrodes corresponding to a second direction, wherein each of the second set of electrodes is configured to form a current loop. The plurality of electrodes are configured to be operable in both a first sensing mode and a second sensing mode, wherein in the first sensing mode, the second set of electrodes are operated to provide respective current loops.

In a further exemplary embodiment, in the second sensing mode, the first set of electrodes is operable as transmitter electrodes and the second set of electrodes is operable as receiver electrodes for two-dimensional capacitive touch sensing; and in the second sensing mode, the first set of electrodes is operable as receiver electrodes and the second set of electrodes is operable as transmitter electrodes for two-dimensional capacitive touch sensing.

In a further exemplary embodiment, in the second sensing mode, respective electrodes of the first set of electrodes are operable as transmitter electrodes and other respective electrodes of the first set of electrodes are operable as receiver electrodes for one-dimensional parallel transcapacitive touch sensing corresponding to the first direction; and in the second sensing mode, respective electrodes of the second set of electrodes are operable as transmitter electrodes and other respective electrodes of the second set of electrodes are operable as receiver electrodes for one-dimensional parallel transcapacitive touch sensing corresponding to the second direction.

In a further exemplary embodiment, the plurality of branches includes a subset of branches which have sub-branches protruding from respective branches of the subset of branches.

In a further exemplary embodiment, the first sensing mode is a stylus sensing mode; and the second sensing mode is a capacitive touch sensing mode.

In a further exemplary embodiment, the second set of electrodes are shaped so as to surround peripheries of respective electrodes of the first set of electrodes; and the first and second sets of electrodes are electrically separated from each other.

In a further exemplary embodiment, each of the second set of electrodes has a first connection to a processing system, a first half, a second half, a second connection to the processing system; the first and second connections to the processing system for a respective electrode of the second set of electrodes are disposed on a first side of the respective electrode; the first half and the second half are electrically connected to each other on a second side of the respective electrode opposite the first side; and the current loop traverses the first connection to the processing system, the first half, the second half, and the second connection to the processing system in sequence.

In a further exemplary embodiment, a portion of a respective electrode of the second set of electrodes corresponding to a respective sensing pixel comprises four parts, wherein two of the four parts are part of the first half and are connected to each other via a first jumper that bypasses a respective first electrode, and the other two of the four parts are part of the second half and connected to each other via a second jumper that bypasses the respective first electrode.

In a further exemplary embodiment, the single integrated layer is a metal mesh layer, and each of the plurality of electrodes is comprised of metal mesh.

In yet another exemplary embodiment, the present application provides a method for performing stylus sensing and capacitive touch sensing using an integrated stylus and capacitive touch sensing layer. The method includes: performing, by a processing system, stylus sensing using the integrated sensing layer; detecting, by the processing system, a location of a stylus in a sensing region of a touch sensor device based on the stylus sensing; performing, by the processing system, capacitive touch sensing using the integrated sensing layer; and detecting, by the processing system, a location of an input object in the sensing region based on the capacitive touch sensing. The integrated sensing layer comprises a first plurality of electrodes and a second plurality electrodes, the second plurality of electrodes is configured to be used as current loops for stylus sensing while performing the stylus sensing and as transmitter or receiver electrodes while performing the capacitive touch sensing, the first plurality of electrodes is configured to be used as transmitter or receiver electrodes or as ground or guard electrodes while performing the capacitive touch sensing, and the first and second pluralities of electrodes are disposed on a same layer of the touch sensor device.

### BRIEF DESCRIPTION OF THE DRAWINGS

For a more detailed understanding of exemplary features of the present disclosure, the appended drawings are provided for illustration purposes. It will be appreciated, however, that the appended drawings illustrate only exemplary embodiments, and are not intended to limit the scope of the claimed subject matter.

FIG. 1 depicts a block diagram of an example input device.

FIG. 2A depicts an example integrated sensor design.

FIG. 2B depicts an example of the working principles of the integrated sensor design of FIG. 2A when operated in an EMR stylus sensing mode.

FIG. 2C depicts an example of the working principles of the integrated sensor design of FIG. 2A when operated in a two-dimensional transcapacitive sensing mode.

FIG. 2D depicts an example of the working principles of the integrated sensor design of FIG. 2A when operated in a one-dimensional parallel transcapacitance sensing mode.

FIG. 3 depicts a respective sensing pixel of the integrated sensor design of FIG. 2A.

FIG. 4 depicts an example of an alternative sensing pixel configuration.

FIG. 5 depicts another example of an alternative sensing pixel configuration.

FIG. 6 depicts yet another example of an alternative sensing pixel configuration.

FIG. 7 depicts an example metal mesh sensor design.

FIG. 8A depicts a zoomed-in view of a first region of FIG. 7.

FIG. 8B depicts a zoomed-in view of a second region of FIG. 7.

FIG. 9 depicts an example flowchart showing a process for performing EMR stylus detection and capacitive touch sensing using an integrated sensor in accordance with an exemplary embodiment of the present disclosure.

FIGS. 10A-10C depict examples of sensing pixel responses in different situations.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The following detailed description is exemplary in nature and is not intended to limit the disclosure or uses of methods and systems described herein. Furthermore, there is no intention to be bound by any expressed or implied theory presented in the preceding technical field, background, summary, brief description of the drawings, or the following detailed description.

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

In the present disclosure, a procedure, logic block, process, or the like, may refer to a self-consistent sequence of steps or instructions leading to a desired result. Steps may require physical manipulations of physical quantities. Usually, although not necessarily, these quantities take the form of electrical or magnetic signals capable of being stored, transferred, combined, compared, and otherwise manipulated in a computer system. It will be appreciated, however, that all of these and similar terms are to be associated with the appropriate physical quantities and are merely convenient labels applied to these quantities.

Unless specifically stated otherwise or unless it would be understood otherwise from context, terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like refer to the actions and processes of a computer system or similar electronic computing device. The computer system or similar electronic computing device may manipulate and transform data represented as physical (electronic) quantities within the computer system’s memories or registers or other such information storage into other data similarly represented as physical quantities within the computer system memories or registers or other such information storage.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. It will be appreciated that the described functionality may be implemented in varying ways for each particular application, but such implementation decisions should not be interpreted as causing a departure from the scope of the present invention. Also, the example input devices may include components other than those shown, including well-known components such as a processor, a memory, and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, causes performance of one or more of the methods described herein. The non-transitory processor-readable storage medium may form part of a computer program product, which may include packaging materials.

The non-transitory processor-readable storage medium may comprise random access memory (RAM) such as synchronous dynamic random-access memory (SDRAM), read only memory (ROM), non-volatile random-access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments discussed herein may be executed by one or more processors (or a processing system). The term “processor,” as used herein may refer to any general-purpose processor, special-purpose processor, controller, microcontroller, and/or state machine capable of executing scripts or instructions of one or more software programs stored in memory.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Exemplary embodiments of the present application provide an input device having a sensing structure with integrates both EMR stylus detection functionality and capacitive touch sensing technology into an integrated sensing layer, and achieves space and cost savings relative to conventional EMR stylus and capacitive touch sensing devices. The integrated sensing structure achieves effective EMR pen detection and touch detection while saving on both space and cost.

In an exemplary embodiment, the integrated sensor device comprises a plurality of transmitter electrodes and a plurality of receiver electrodes in a single layer. The respective transmitter electrodes may comprise at least one trunk structure in a first direction, at least one branch structure in a second direction (wherein the second direction is perpendicular to the first direction and the at least one branch structure is electrically coupled to the trunk structure), and at least one sub-branch structure in the first direction (wherein the at least one sub-branch structure is electrically coupled to the at least one branch structure). Respective receiver electrodes may be adjacent to respective transmitter electrodes and surround the periphery of respective transmitter electrodes. A physical gap between respective receiver electrodes and respective transmitter electrodes provides electrical separation between respective transmitter electrodes and respective receiver electrodes. A jumper may electrically connect a portion of the receiver electrode on one side of the at least one trunk structure with a portion of the receiver electrode on the opposite side of the at least one trunk structure.

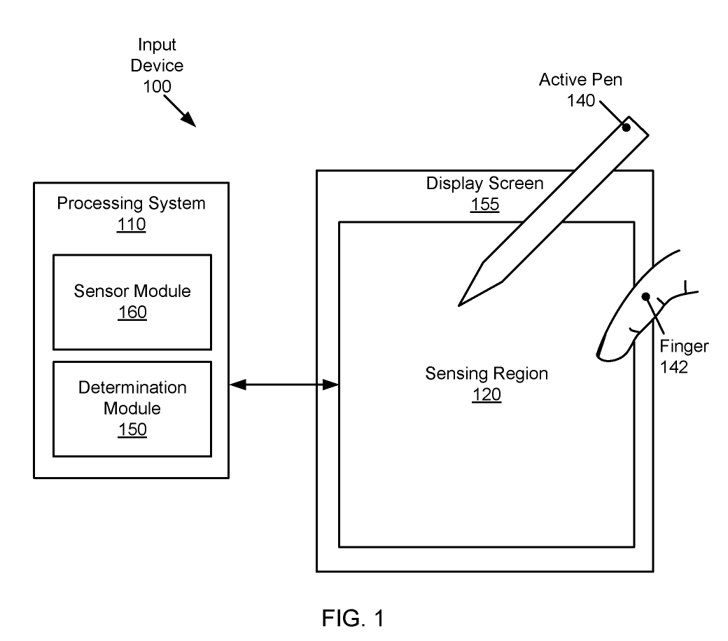

FIG. 1 is a block diagram of an exemplary input device 100 to which exemplary embodiments of the present disclosure are applicable. The input device 100 may be configured to provide input to an electronic system. As used in this document, the term “electronic system” (or “electronic device”) broadly refers to any system capable of electronically processing information. Some non-limiting examples of electronic systems include personal computers, such as desktop computers, laptop computers, netbook computers, tablets, web browsers, e-book readers, and personal digital assistants (PDAs). Additional example electronic systems include composite input devices, such as physical keyboards that include input device 100 and separate joysticks or key switches. Further example electronic systems include peripherals, such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system may be a host or a slave to the input device.

In FIG. 1, the input device 100 is shown as a touch sensor device (e.g., “touchpad” or a “touch sensor device”) configured to sense input provided by one or more input objects in a sensing region 120. Example input objects include styli, an active pen 140, and fingers 142. Further, which particular input objects are in the sensing region may change over the course of one or more gestures. For example, a first input object may be in the sensing region to perform the first gesture, subsequently, the first input object and a second input object may be in the above surface sensing region, and, finally, a third input object may perform the second gesture. To avoid unnecessarily complicating the description, the singular form of input object is used and refers to all of the above variations.

The sensing region 120 encompasses any space above, around, in and/or near the input device 100 in which the input device 100 is able to detect user input (e.g., user input provided by one or more input objects). The sizes, shapes, and locations of particular sensing regions may vary widely from embodiment to embodiment.

The input device 100 may use any combination of sensor components and sensing technologies to detect user input in the sensing region 120. The input device 100 includes one or more sensing elements for detecting user input. The sensing elements may be capacitive.

In some capacitive implementations of the input device 100, voltage or current is applied to create an electric field. Nearby input objects cause changes in the electric field and produce detectable changes in capacitive coupling that may be detected as changes in voltage, current, or the like.

Some capacitive implementations utilize arrays or other regular or irregular patterns of capacitance sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g., system ground), and by detecting the capacitive coupling between the sensor electrodes and input objects. The reference voltage may by a substantially constant voltage or a varying voltage and in various embodiments; the reference voltage may be system ground. Measurements acquired using absolute capacitance sensing methods may be referred to as absolute capacitive measurements.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a mutual capacitance sensing method operates by detecting the capacitive coupling between one or more transmitter sensor electrodes (also “transmitter electrodes” or “transmitter”) and one or more receiver sensor electrodes (also “receiver electrodes” or “receiver”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. The reference voltage may be a substantially constant voltage and in various embodiments; the reference voltage may be system ground.

In some embodiments, transmitter sensor electrodes and receiver sensor electrodes may both be modulated. The transmitter electrodes may be modulated relative to the receiver electrodes to transmit transmitter signals and to facilitate receipt of resulting signals. A resulting signal may include effect(s) corresponding to one or more transmitter signals, and/or to one or more sources of environmental interference (e.g., other electromagnetic signals). The effect(s) may be the transmitter signal, a change in the transmitter signal caused by one or more input objects and/or environmental interference, or other such effects. Sensor electrodes may be dedicated transmitters or receivers or may be configured to both transmit and receive. Measurements acquired using mutual capacitance sensing methods may be referred to as mutual capacitance measurements.

In FIG. 1, a processing system 110 is shown as part of the input device 100. The processing system 110 is configured to operate the hardware of the input device 100 to detect input in the sensing region 120. The processing system 110 includes parts of or all of one or more integrated circuits (ICs) and/or other circuitry components. For example, a processing system 110 for a mutual capacitance sensor device may include transmitter circuitry configured to transmit signals with transmitter sensor electrodes, and/or receiver circuitry configured to receive signals with receiver sensor electrodes. Further, a processing system 110 for an absolute capacitance sensor device may include driver circuitry configured to drive absolute capacitance signals onto sensor electrodes, and/or receiver circuitry configured to receive signals with those sensor electrodes. In one or more embodiments, a processing system 110 for a combined mutual and absolute capacitance sensor device may include any combination of the above described mutual and absolute capacitance circuitry. A processing system 110 may further include receiver circuitry configured to receive signals emitted by a different source, e.g., an active pen 140. The signals by the active pen 140 may be received by the receiver sensor electrodes, while transmit signals are not necessarily emitted by transmitter sensor electrodes.

In some embodiments, the processing system 110 also includes electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to the sensing element(s) of the input device 100, and one or more components elsewhere. For example, the input device 100 may be a peripheral coupled to a computing device, and the processing system 110 may include software configured to run on a central processing unit of the computing device and one or more ICs (perhaps with associated firmware) separate from the central processing unit. As another example, the input device 100 may be physically integrated in a mobile device, and the processing system 110 may include circuits and firmware that are part of a main processor of the mobile device. In some embodiments, the processing system 110 is dedicated to implementing the input device 100. In other embodiments, the processing system 110 also performs other functions, such as operating display screens 155, driving haptic actuators, etc.

The processing system 110 may be implemented as a set of modules that handle different functions of the processing system 110. Each module may include circuitry, firmware, software, or a combination thereof. In various embodiments, different combinations of modules may be used. For example, as shown in FIG. 1, the processing system 110 may include a determination module 150 and a sensor module 160. The determination module 150 may include functionality to determine when at least one input object is in a sensing region, signal to noise ratio, positional information of an input object, a gesture, an action to perform based on the gesture, a combination of gestures or other information, and/or other operations. For example, the determination module 150 may be implemented in the form of a controller and/or processing circuitry.

The sensor module 160 may include functionality to drive the sensing elements to transmit transmitter signals and receive the resulting signals. For example, the sensor module 160 may include sensory circuitry that is coupled to the sensing elements. The sensor module 160 may include, for example, a transmitter module and a receiver module. The transmitter module may include transmitter circuitry that is coupled to a transmitting portion of the sensing elements. The receiver module may include receiver circuitry coupled to a receiving portion of the sensing elements and may include functionality to receive the resulting signals. The receiver module of the sensor module 160 may receive resulting signals from sensor electrodes in the electrode pattern using a capacitive sensing signal having a sensing frequency, e.g., generated by the transmitter module. The resulting signals may include desired signals, such as active pen data or signal components caused by an input object being in proximity to the electrode pattern, or undesired signals, such as noise or interference. As will be described in greater detail below, the sensor module 160 may perform one or more demodulation operations on the resulting signal.

Although FIG. 1 shows a determination module 150 and a sensor module 160, alternative or additional modules may exist in accordance with one or more embodiments. Such alternative or additional modules may correspond to distinct modules or sub-modules than one or more of the modules discussed above. Example alternative or additional modules include hardware operation modules for operating hardware such as sensor electrodes and display screens 155, data processing modules for processing data such as sensor signals and positional information, reporting modules for reporting information, and identification modules configured to identify gestures, such as mode changing gestures, and mode changing modules for changing operation modes. Further, the various modules may be combined in separate integrated circuits. For example, a first module may be comprised at least partially within a first integrated circuit and a separate module may be comprised at least partially within a second integrated circuit. Further, portions of a single module may span multiple integrated circuits. In some embodiments, the processing system as a whole may perform the operations of the various modules.

In some embodiments, the processing system 110 responds to user input (or lack of user input) in the sensing region 120 directly by causing one or more actions. Example actions include changing operation modes, as well as graphical user interface (GUI) actions such as cursor movement, selection, menu navigation, and other functions. In some embodiments, the processing system 110 provides information about the input (or lack of input) to some part of the electronic system (e.g., to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions.

In some embodiments, the input device 100 includes a touch screen interface, and the sensing region 120 overlaps at least part of an active area of a display screen 155. For example, the input device 100 may include substantially transparent sensor electrodes overlaying the display screen and provide a touch screen interface for the associated electronic system. The display screen may be any type of dynamic display capable of displaying a visual interface to a user and may include any type of light emitting diode (LED), organic LED (OLED), cathode ray tube (CRT), liquid crystal display (LCD), plasma, electroluminescence (EL), or other display technology. The input device 100 and the display screen 155 may share physical elements. For example, some embodiments may utilize some of the same electrical components for displaying and sensing. In various embodiments, one or more display electrodes of a display device may be configured for both display updating and input sensing. As another example, the display screen 155 may be operated in part or in total by the processing system 110.

FIG. 1 shows merely one exemplary configuration of components, and it will be appreciated that other configurations may be used without departing from the scope of the disclosure. For example, various components may be combined to create a single component. As another example, the functionality performed by a single component may be performed by two or more components. Further, while a configuration for touch sensing is described, other parameters such as force may be sensed.

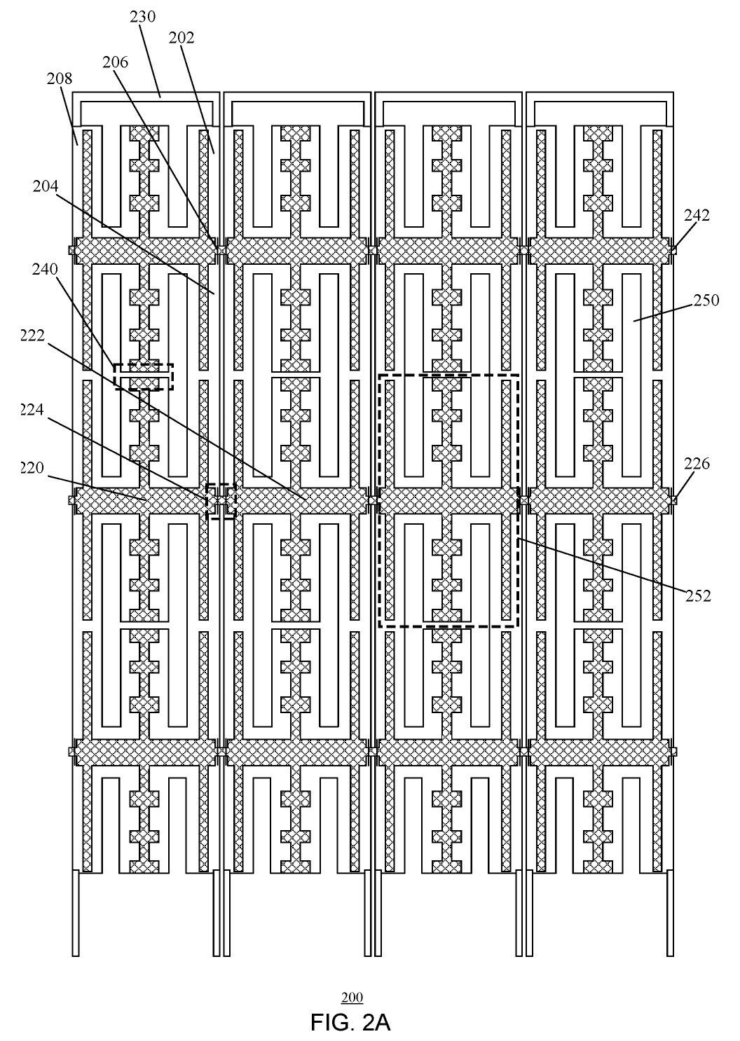

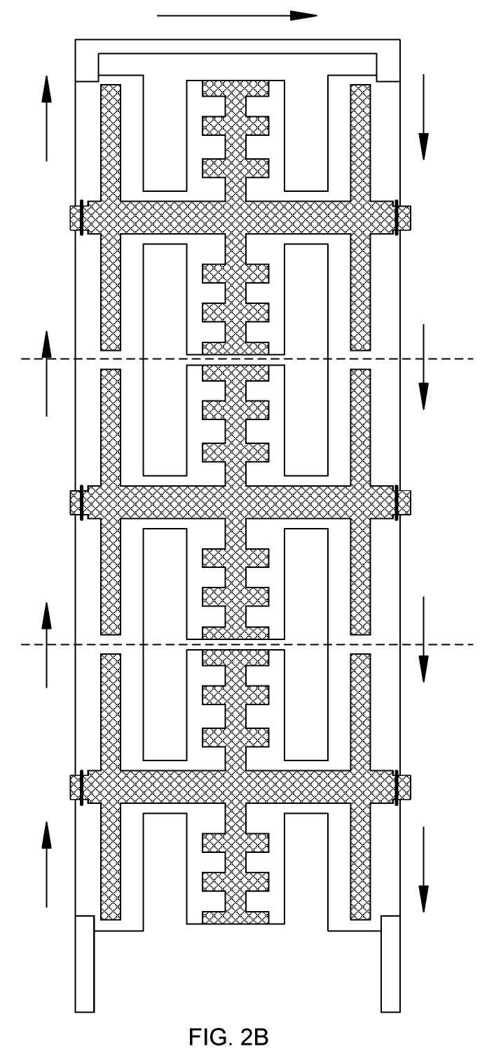

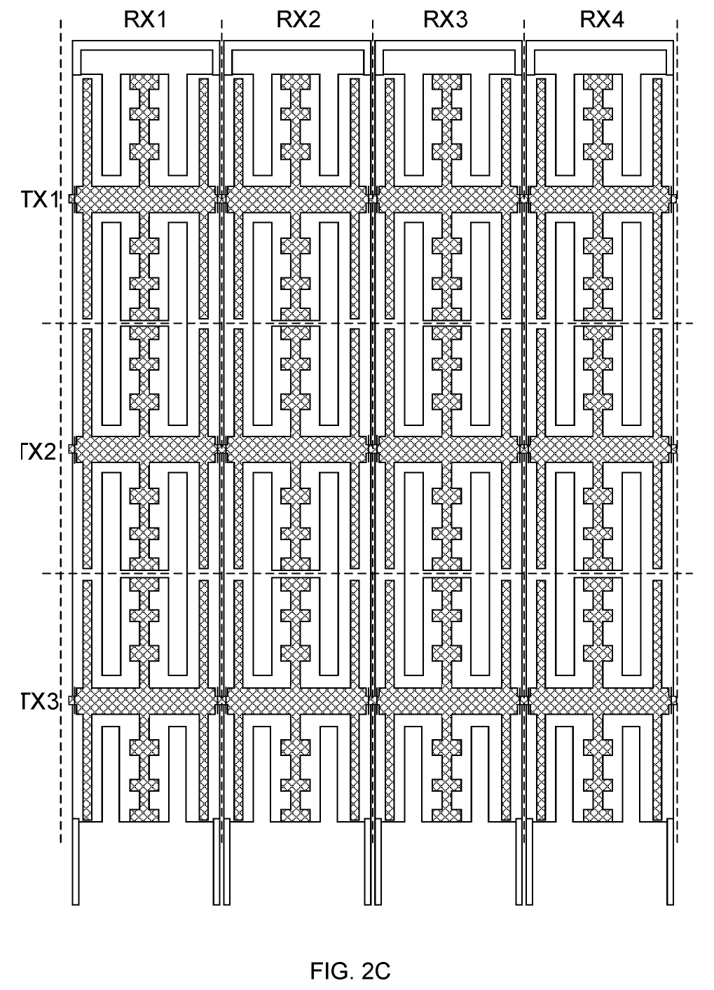

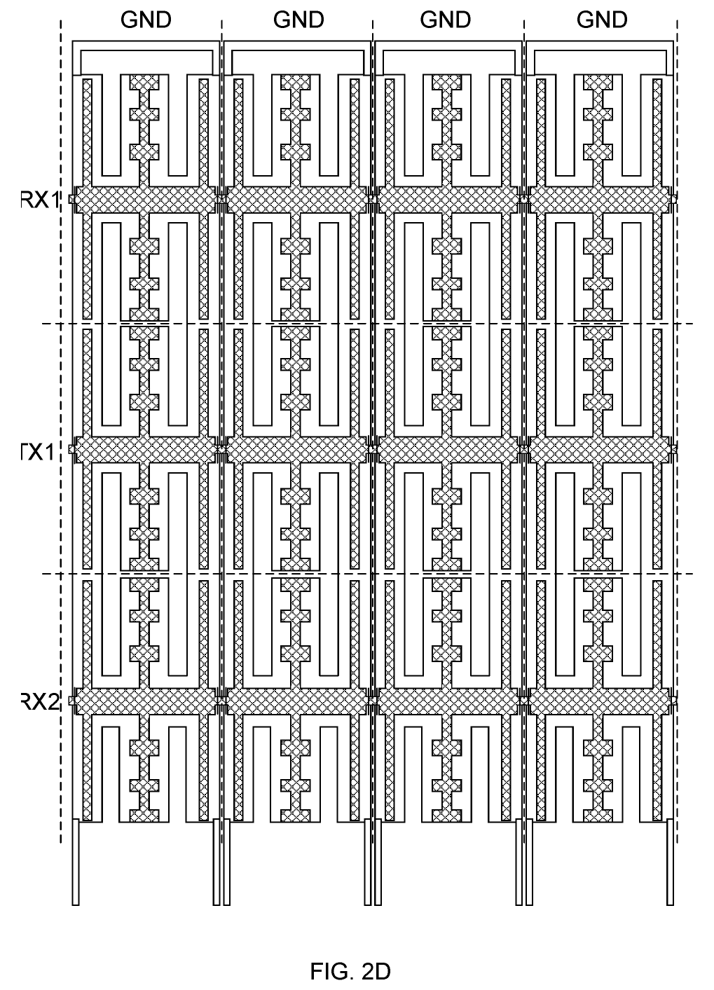

FIG. 2A depicts an example integrated sensor design 200. In the depicted example, four vertical electrodes and three horizontal electrodes are shown for illustration purposes, but it will be appreciated that, in practice, exemplary implementations of an integrated sensor may have a different (e.g., larger) number of vertical electrodes and horizontal electrodes. In an exemplary implementation for a smartphone, a sensor array may include 18 transmitter electrodes and 40 receiver electrodes. In another exemplary implementation for a foldable smartphone, there may be 36 transmitter electrodes and 44 receiver electrodes.

Each horizontal electrode has a horizontal trunk and a plurality of vertical branches protruding from the trunk. Each vertical electrode has two sides connected by a respective connection across the top. The horizontal electrodes and the vertical electrodes are disposed in a same metal layer of the integrated sensor device.

For example, region 202 is part of the right side of the leftmost vertical electrode depicted in FIG. 2A. Region 204 is another part of the right side of the leftmost vertical electrode depicted in FIG. 2A. Jumper 206 electrically connects region 202 and region 204 as part of forming the leftmost vertical electrode. Other jumpers are also depicted in FIG. 2A where respective portions of receiver electrodes are electrically coupled to each other across a portion of the layer occupied by a respective transmitter electrode. Additionally, connection 230 electrically connects region 202 (part of the right side of the leftmost vertical electrode) to region 208 (part of the left side of the leftmost vertical electrode) as part of forming the leftmost vertical electrode.

Regions 220 and 222 are part of the middle horizontal electrode 226 depicted in FIG. 2A. Region 224 shows two vertical jumpers going over the middle horizontal electrode 226, and it will be appreciated that regions 220 and 222 of the middle horizontal electrode 226 are electrically connected to another via the portion of the middle horizontal electrode 226 that is disposed under the two vertical jumpers.

Region 240 of FIG. 2A illustrates that there is a gap between the middle horizontal electrode 226 of FIG. 2A and the top horizontal electrode 242 of FIG. 2A. It will thus be appreciated that the two horizontal electrodes are electrically separated. It will further be appreciated that each of the horizontal electrodes is electrically separated from each of the vertical electrodes (e.g., there may be gaps along respective borders between vertical and horizontal electrodes). The electrical separations may be implemented, for example, by providing insulating material between the respective electrodes.

Each side of each vertical electrode shown in FIG. 2A also includes respective cutout regions (e.g., cutout region 250 of the rightmost vertical electrode, proximate to top horizontal electrode 242). These cutout regions reduce background capacitance (C_{b}) and the coupling capacitance between an input object (e.g., a finger) and the electrodes.

Each of the four vertical electrodes shown in FIG. 2A is connected to a processing system via two connections (shown at the bottom of FIG. 2A), thereby allowing each of the four vertical electrodes to provide current loops for EMR stylus sensing (x-direction). Similarly, each of the three horizontal electrodes shown in FIG. 2A is connected to the processing system via two connections (one connection on the left and one connection on the right, each with appropriate routing to the processing system), thereby allowing each of the three horizontal electrodes to provide current loops for EMR stylus sensing (y-direction).

The array of electrodes shown in FIG. 2A, which are disposed in a single integrated layer, may be operated by the processing system in two or more different modes. In an EMR stylus sensing mode, the vertical electrodes are operated to provide current loops through which the presence, location, and/or movement of an EMR stylus may be detected with respect to the x-direction, and the horizontal electrodes are operated to provide current loops through which the presence, location, and/or movement of an EMR stylus may be detected with respect to the y-direction. Additionally, a variety of capacitive touch modes and/or other modes of operations may be provided. For example: in a first capacitive touch mode, the horizontal electrodes are operated as transmitter electrodes, and the vertical electrodes are operated as receiver electrodes; in a second capacitive touch mode, the horizontal electrodes are operated as receiver electrodes, and the vertical electrodes are operated as transmitter electrodes; in a third capacitive touch mode or a first moisture detection mode, certain horizontal electrodes are operated as transmitter electrodes and other horizontal electrodes are operated as receiver electrodes (with parallel transcapacitive sensing being performed); and/or in a fourth capacitive touch mode or a second moisture detection mode, certain vertical electrodes are operated as transmitter electrodes and other vertical electrodes are operated as receiver electrodes (with parallel transcapacitive sensing being performed).

The integrated sensor design 200 of FIG. 2A achieves good performance when operated in the EMR stylus sensing mode (including good aperture for picking up a current signal from an EMR pen), good performance for capacitive touch sensing (including good pixel response, for example, with respect to touch accuracy and linearity; including increased interaction between transmitter and receiver electrodes; and including increased capacitance based on increasing fringing capacitance between transmitter and receiver electrodes), good low-ground mass (LGM) performance, and good parallel transcapacitive performance (when operated in a parallel transcapacitive sensing mode, the integrated sensor design provides an effective amount of coupling between adjacent parallel electrodes that achieves good sensing results).

FIG. 2B depicts an example of the working principles of the integrated sensor design of FIG. 2A when operated in an EMR stylus sensing mode. In FIG. 2B, a single vertical electrode of an array of electrodes is illustrated. As shown by the depicted directional arrows, the vertical electrode forms a current loop. Based on the current loop, a processing system connected to the electrode array is able to detect a location of an EMR stylus proximate to the sensing region of the sensor device with respect to the x-direction. It will be appreciated that the horizontal electrodes may also be configured to provide current loops (e.g., via appropriate routing to the processing system connected to the left and right sides of each horizontal electrode shown in FIG. 2A) to detect a location of the EMR stylus with respect to the y-direction.

FIG. 2C depicts an example of the working principles of the integrated sensor design of FIG. 2A when operated in a two-dimensional transcapacitive sensing mode. In this illustrative example, sensing signals may be driven onto transmitter electrodes TX1, TX2 and TX3 by a processing system, and the processing system obtains resulting signals corresponding to the sensing signals via receiver electrodes RX1, RX2, RX3 and RX4. The respective intersections between the illustrated transmitter electrodes and the illustrated receiver electrodes thus provide 12 sensing pixels, and the location of an input object in the sensing region can be determined by the processing system based on the obtained resulting signals.

FIG. 2D depicts an example of the working principles of the integrated sensor design of FIG. 2A when operated in a one-dimensional parallel transcapacitance sensing mode. In this illustrative example, sensing signals may be driven onto horizontal transmitter electrode TX1 by a processing system, and the processing system obtains resulting signals corresponding to the sensing signals via horizontal receiver electrodes RX1 and RX2. The vertical electrodes may be grounded or set to a fixed voltage. The processing system may determine a 1D capacitive touch profile based on the resulting signals, whereby the location of an input object in the sensing region can be determined by the processing system with respect to one dimension (e.g., with respect to a Y-axis).

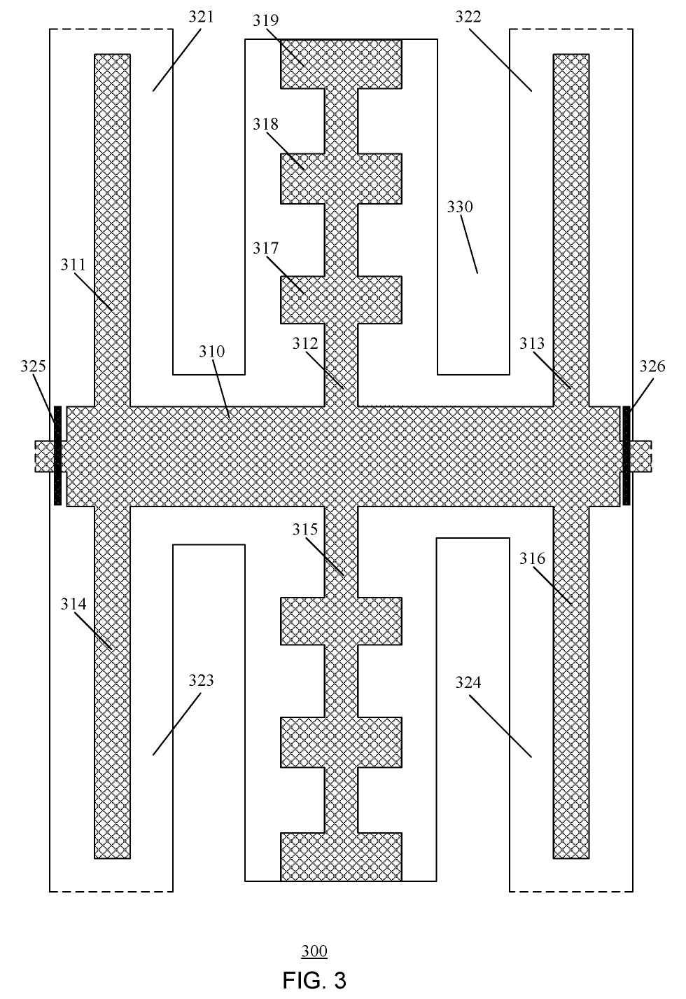

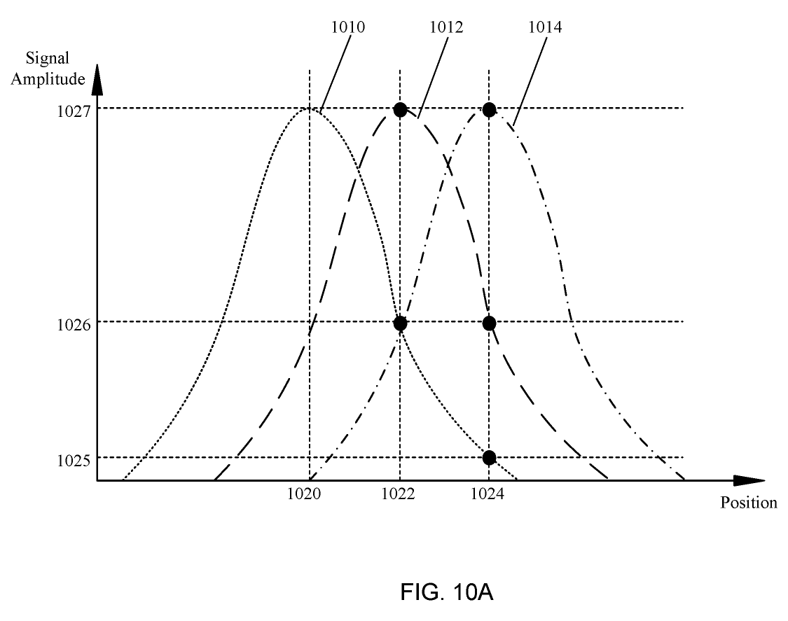

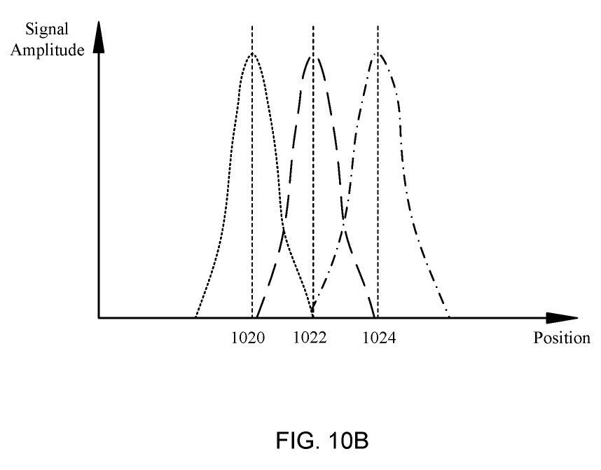

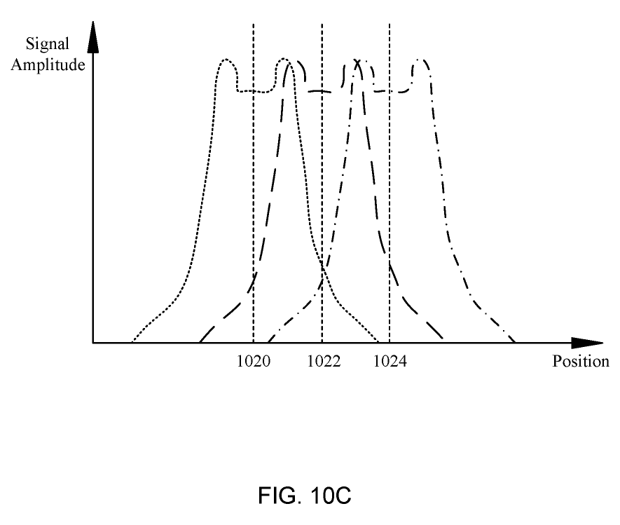

FIG. 3 depicts a respective sensing pixel 300 of the integrated sensor design of FIG. 2A (corresponding to region 252 in FIG. 2A). The respective sensing pixel 300 includes a portion of horizontal electrode and a portion of a vertical electrode. The depicted portion of the horizontal electrode includes a horizontal trunk 310 and a plurality of vertical branches 311, 312, 313, 314, 315, 316 (which protrude from and are perpendicular to the horizontal trunk 310). Some of the vertical branches (e.g., middle branches 312, 315) may further include horizontal sub-branches (e.g., sub-branches 317, 318, 319) protruding from and perpendicular to the vertical branches. Including these sub-branches (e.g., 317, 318, 319) helps to guarantee a single peak in the pixel response provided by sensing pixel 300 (discussed in further detail below in connection with FIGS. 10A-10C). The horizontal trunk 310 may further extend left and/or right and pass through other sensing pixels of a sensing region.

The depicted portion of the vertical electrode includes four parts of the vertical electrode—a top left part 321, a top right part 322, a bottom left part 323, and a bottom right part 324. The top left part 321 is electrically connected to the bottom left part 323 via jumper 325, and the top right part 322 is electrically connected to the bottom right part 324 via jumper 326. Additionally, the left parts 321, 323 are electrically connected to the right parts 322, 324 via a connector (as discussed and depicted in connection with FIG. 2A, the connection between the two halves of the vertical electrode provide a large current loop for picking up a signal from an EMR stylus). The vertical electrode further includes cutout regions (e.g., cutout region 330), which have less contribution to an input object signal (ΔCₜ) so as to reduce background capacitance. The vertical electrode may further extend up and/or down and pass through other sensing pixels of a sensing region, and the vertical electrode may form an EMR current loop in an EMR stylus sensing mode of the sensor device, whereby a current traverses bottom left part 323, jumper 325, top left part 321, a connector, top right part 322, jumper 326, and bottom right part 324 in that order (as shown in FIG. 2B).

As discussed above, although the periphery of the horizontal electrode is surrounded by respective portions of the vertical electrode in a single layer, the horizontal electrode is electrically separated from the vertical electrode (e.g., there may be gaps along respective borders between the horizontal electrode and the vertical electrode).

It will be appreciated that the exemplary sensing pixel configuration shown in FIG. 3 is merely one example, and sensing pixels in other exemplary embodiments of the present disclosure may be configured in many other ways. For example, the dimensions of each part may be different; the sub-branches may have a different shape other than a rectangular shape (e.g., a sawtooth design); and/or there may be more or less cutout regions and/or the cutout regions may be differently shaped.

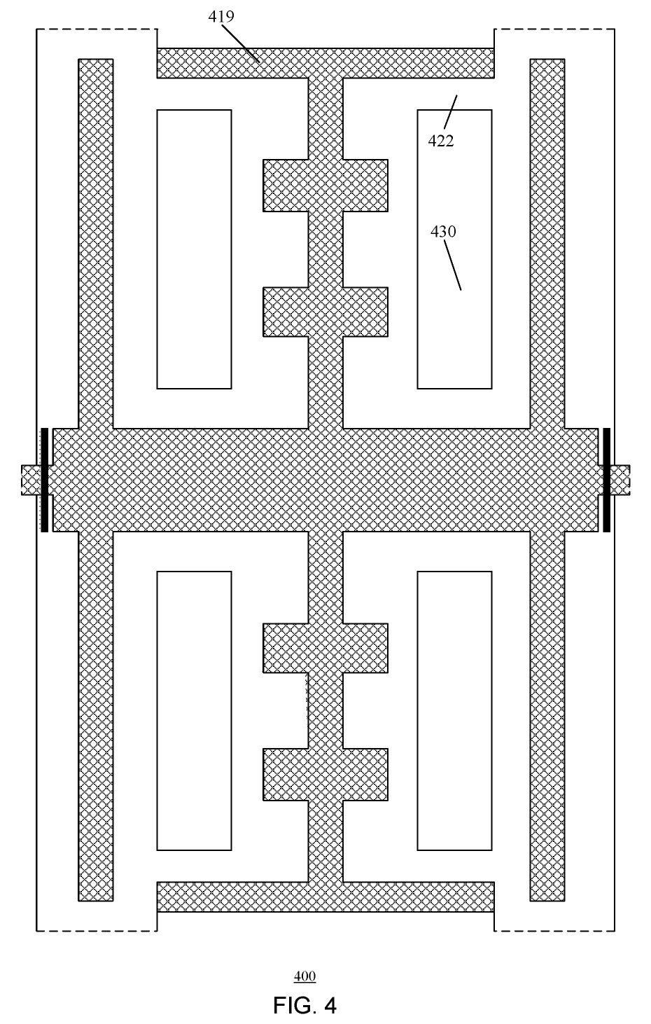

FIG. 4 depicts an example of an alternative sensing pixel configuration 400. The configuration of the sensing pixel shown in FIG. 4 is similar to that of the sensing pixel of FIG. 3, but there are some differences in the shape of the top and bottom sub-branches of the middle branches (e.g., sub-branch 419 is relatively wider and thinner, which provides a relatively stronger pixel response overlap between adjacent horizontal electrodes, which may be beneficial in the context of parallel transcapacitive sensing). Cutout 430 and top right part 422 of the vertical electrode of FIG. 4 also have a different shape relative to cutout 330 and top right part 322 of FIG. 3.

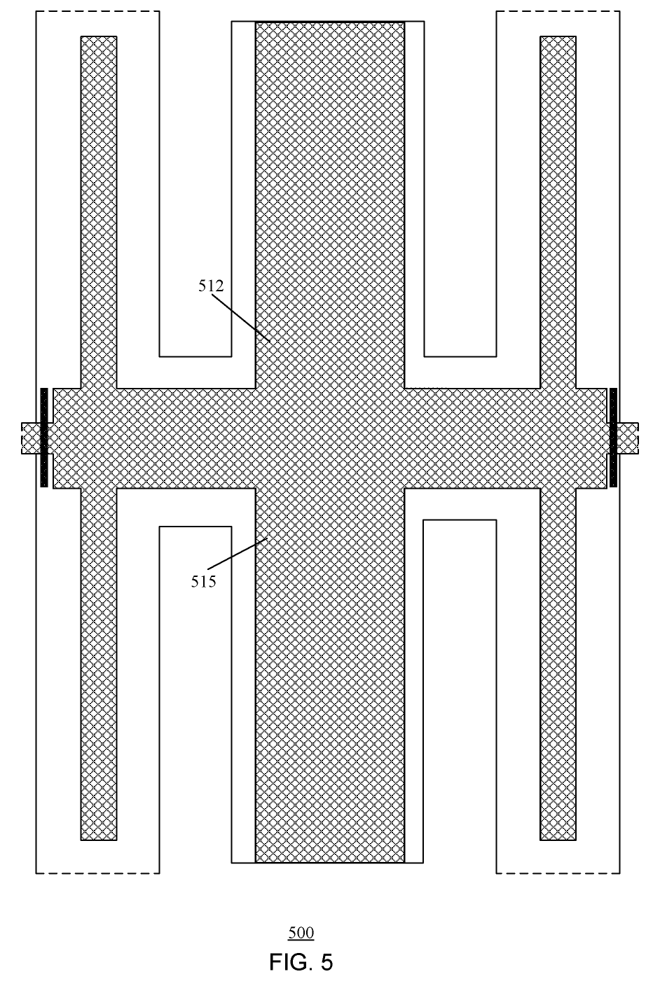

FIG. 5 depicts another example of an alternative sensing pixel configuration 500. The configuration of the sensing pixel shown in FIG. 5 is similar to that of the sensing pixel of FIG. 3, but the middle branches 512, 515 of FIG. 5 are different from the middle branches 312, 315 of FIG. 3 in that the middle branches 512, 515 of FIG. 5 are relatively wider and do not have sub-branches.

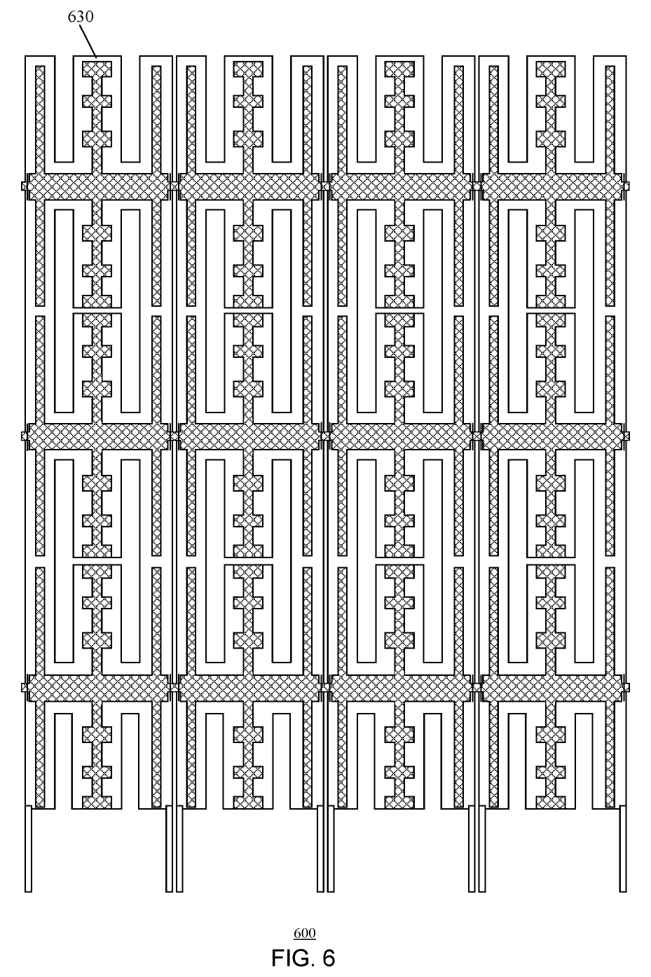

FIG. 6 depicts yet another example of an alternative sensing pixel configuration 600, wherein the top row of pixels do not utilize separate connectors (such as connection 230 shown in FIG. 2A) for connecting the two halves of each vertical electrode. Instead, the two halves of each respective vertical electrode are electrically connected via a part of the electrode (e.g., 630) which extends above respective middle branches at the top of each sensing pixel along a top row of the sensing array.

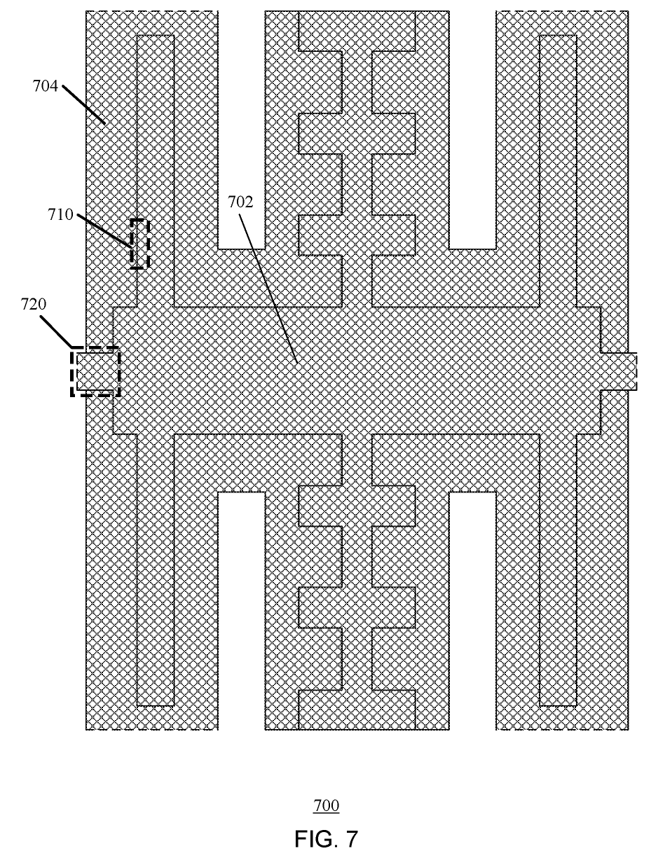

The integrated sensor layer in which the electrodes depicted in FIGS. 2A-6 are disposed may be implemented in the form of a metal mesh layer. FIG. 7 depicts an example 700 of the sensing pixel configuration of FIG. 3 implemented in a metal mesh layer. Horizontal electrode 702 and vertical electrode 704 may each be formed of metal mesh, and each metal mesh electrode may, for example, comprise interconnected diamond-shaped metal traces. It will be appreciated that other types of metal mesh (and not necessarily diamond-shaped) may be utilized as well.

The metal mesh layer may be disposed above a display panel layer, with holes in the metal mesh layer being aligned to display pixels of the display panel layer, such that contents of the display are visible through the metal mesh layer.

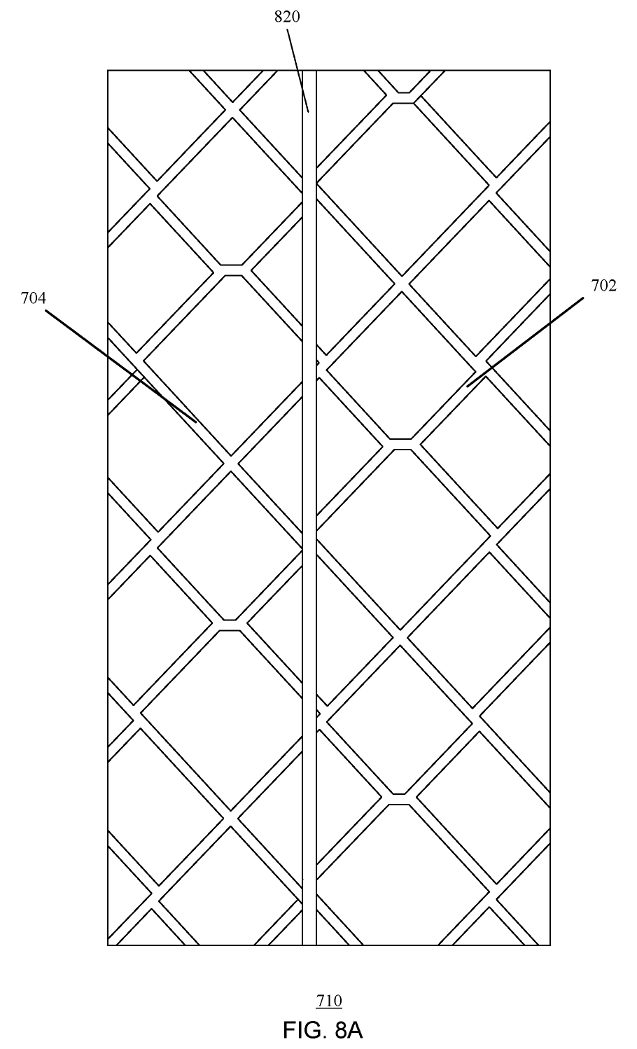

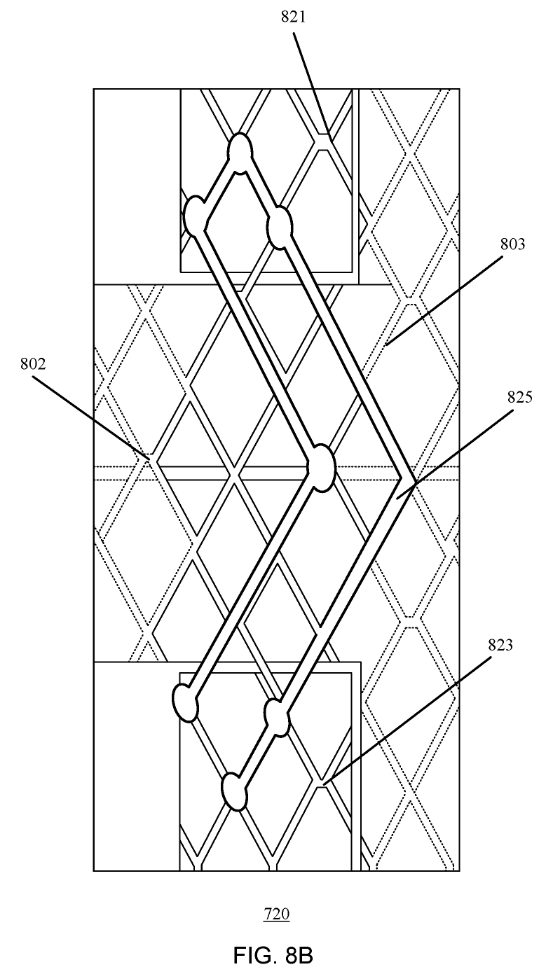

FIG. 8A depicts a zoomed-in view of region 710 of FIG. 7. As shown in FIG. 8A, the metal mesh vertical electrode 704 is separated from the metal mesh horizontal electrode 702 by a gap 820.

FIG. 8B depicts a zoomed-in view of region 720 of FIG. 7. The top left part 821 of metal mesh vertical electrode 704 is electrically connected to the bottom left part 823 of metal mesh vertical electrode 704 via jumper 825. Jumper 825 may be formed in a different layer above the integrated sensor layer in which the metal mesh vertical electrode 704 and the metal mesh horizontal electrode 702 are formed. Regions 802 and 803 are both part of the metal mesh transmitter electrode and are electrically connected to each other underneath jumper 825 in the integrated sensor layer.

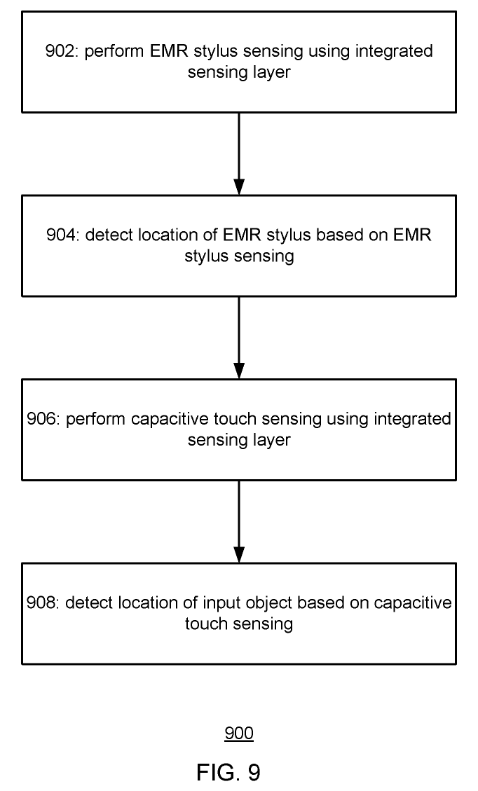

FIG. 9 depicts an example flowchart showing a process for performing EMR stylus detection and capacitive touch sensing using an integrated sensor in accordance with an exemplary embodiment of the present disclosure.

At stage 902, a processing system of the touch sensor performs EMR stylus sensing using an integrated sensing layer, for example, as discussed above in connection with FIG. 2B. Based on the EMR stylus sensing, the processing system detects presence, location and/or movement of an EMR stylus within a sensing region of the touch sensor at stage 904.

At stage 906, the processing system performs capacitive touch sensing using the integrated sensing layer, for example, as discussed above in connection with FIG. 2C or FIG. 2D. Based on the capacitive touch sensing, the processing system detects presence, location and/or movement of an input object (e.g., a finger) within the sensing region of the touch sensor at stage 908.

FIGS. 10A-10C depict examples of sensing pixel responses in different situations. FIG. 10A corresponds to a desirable response, whereby the presence, position, and/or motion of an input object (e.g., a finger or stylus) with respect to a sensing region can be accurately and reliably detected by a processing system. FIGS. 10B-10C correspond to less desirable responses, where sensing may be compromised. Exemplary embodiments of the present disclosure are able to obtain pixel responses corresponding to the sensing pixel responses shown in FIG. 10A.

The x-axis in FIGS. 10A-10C correspond to positions (in one dimension) of a touch sensing region, and the y-axis in FIGS. 10A-10C correspond to amplitude of a detected signal. The detected signal may be a capacitance, a voltage, or another type of signal.

A first electrode is positioned at location 1020, a second electrode is positioned at location 1022, and a third electrode is positioned at location 1024. Traces 1010, 1012, and 1014 represent the amplitudes of respective signals measured by the first, second and third electrodes corresponding to different positions of an input object. For example, for an input object at location 1022, the first and third electrodes measure signal amplitudes at level 1026, and the second electrode measures a signal amplitude at level 1027. To provide another example, for an input object at location 1024, the third electrode measures a signal amplitude at level 1027, the second electrode measures a signal amplitude at level 1026, and the first electrode measures a signal amplitude at level 1025 (near-zero).

Thus, for sensor devices that have the sensing pixel response capability of FIG. 10A (i.e., sensor devices according to exemplary embodiments of the present disclosure), the position of an input object may be determined based on the relative signal amplitudes from multiple electrodes proximate to the input object (e.g., finger and EMR stylus), which allows for accurate and reliable determination of input object presence, location, and/or movement.

FIGS. 10B-10C are examples of less desirable pixel responses generated by certain conventional sensor devices. In FIG. 10B, the peaks of respective traces corresponding to respective electrodes are too narrow, such that an input object at a particular location may only be detectable by one respective electrode. This results in poor performance in determining input object location, particularly when the input object is located between two electrodes. In FIG. 10C, the respective traces corresponding to respective electrodes have multiple peaks and exhibit non-linear behavior near the peaks. This results in erroneous responses from the touch system.

It will be appreciated that terms such as horizontal, vertical, top, and bottom have been used herein for convenience of description with respect to describing the figures, but embodiments of the present disclosure are not limited to the orientations shown in the figures.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments are described herein. Variations of those exemplary embodiments may become apparent to those of ordinary skill in the art upon reading the foregoing description. It is understood that skilled artisans are able to employ such variations as appropriate, and the invention may be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A system, comprising:
a plurality of electrodes disposed in a single integrated layer, including a first set of electrodes corresponding to a first direction and a second set of electrodes corresponding to a second direction, wherein each of the first set of electrodes comprises a trunk and a plurality of branches protruding from the trunk, and wherein each of the second set of electrodes is configured to form a current loop; and
a processing system configured to:
operate the plurality of electrodes in a first sensing mode, wherein the first sensing mode, the second set of electrodes are operated to provide respective current loops, and wherein in the first sensing mode, the processing system is configured to determine a location of a stylus in a sensing region corresponding to the plurality of electrodes; and
operate the plurality of electrodes in a second sensing mode, wherein in the second sensing mode, the processing system is configured to determine a location of an input object in the sensing region.

2. The system according to claim 1, wherein in the second sensing mode, the first set of electrodes is operable as transmitter electrodes and the second set of electrodes is operable as receiver electrodes for two-dimensional capacitive touch sensing; and
wherein in the second sensing mode, the first set of electrodes is operable as receiver electrodes and the second set of electrodes is operable as transmitter electrodes for two-dimensional capacitive touch sensing.

3. The system according to claim 1, wherein in the second sensing mode, respective electrodes of the first set of electrodes are operable as transmitter electrodes and other respective electrodes of the first set of electrodes are operable as receiver electrodes for one-dimensional parallel transcapacitive touch sensing corresponding to the first direction; and
wherein in the second sensing mode, respective electrodes of the second set of electrodes are operable as transmitter electrodes and other respective electrodes of the second set of electrodes are operable as receiver electrodes for one-dimensional parallel transcapacitive touch sensing corresponding to the second direction.

4. The system according to claim 1, wherein the plurality of branches includes a subset of branches which have sub-branches protruding from respective branches of the subset of branches.

5. The system according to claim 1, wherein the plurality of branches include one or more branches having a sawtooth shape.

6. The system according to claim 1, wherein the second set of electrodes are shaped so as to surround peripheries of respective electrodes of the first set of electrodes; and
wherein the first and second sets of electrodes are electrically separated from each other.

7. The system according to claim 1, wherein each of the second set of electrodes has a first connection to the processing system, a first half, a second half, a second connection to the processing system;
wherein the first and second connections to the processing system for a respective electrode of the second set of electrodes are disposed on a first side of the respective electrode;
wherein the first half and the second half are electrically connected to each other on a second side of the respective electrode opposite the first side; and
wherein the current loop traverses the first connection to the processing system, the first half, the second half, and the second connection to the processing system in sequence.

8. The system according to claim 7, wherein a portion of a respective electrode of the second set of electrodes corresponding to a respective sensing pixel comprises four parts, wherein two of the four parts are part of the first half and are connected to each other via a first jumper that bypasses a respective first electrode, and the other two of the four parts are part of the second half and connected to each other via a second jumper that bypasses the respective first electrode.

9. The system according to claim 1, wherein the single integrated layer is a metal mesh layer, and each of the plurality of electrodes is comprised of metal mesh.

10. The system according to claim 1, wherein the first sensing mode is a stylus sensing mode, and the stylus is configured to resonate electromagnetically; and
wherein the second sensing mode is a capacitive touch sensing mode.

11. A sensor apparatus, comprising:
a plurality of electrodes disposed in a single integrated layer, wherein the plurality of electrodes includes:
a first set of electrodes corresponding to a first direction, wherein each of the first set of electrodes comprises a trunk and a plurality of branches protruding from the trunk; and
a second set of electrodes corresponding to a second direction, wherein each of the second set of electrodes is configured to form a current loop;
wherein the plurality of electrodes are configured to be operable in both a first sensing mode and a second sensing mode, wherein in the first sensing mode, the second set of electrodes are operated to provide respective current loops.

12. The sensor apparatus according to claim 11, wherein in the second sensing mode, the first set of electrodes is operable as transmitter electrodes and the second set of electrodes is operable as receiver electrodes for two-dimensional capacitive touch sensing; and
wherein in the second sensing mode, the first set of electrodes is operable as receiver electrodes and the second set of electrodes is operable as transmitter electrodes for two-dimensional capacitive touch sensing.

13. The sensor apparatus according to claim 11, wherein in the second sensing mode, respective electrodes of the first set of electrodes are operable as transmitter electrodes and other respective electrodes of the first set of electrodes are operable as receiver electrodes for one-dimensional parallel transcapacitive touch sensing corresponding to the first direction; and
wherein in the second sensing mode, respective electrodes of the second set of electrodes are operable as transmitter electrodes and other respective electrodes of the second set of electrodes are operable as receiver electrodes for one-dimensional parallel transcapacitive touch sensing corresponding to the second direction.

14. The sensor apparatus according to claim 11, wherein the plurality of branches includes a subset of branches which have sub-branches protruding from respective branches of the subset of branches.

15. The sensor apparatus according to claim 11, wherein the first sensing mode is a stylus sensing mode; and
wherein the second sensing mode is a capacitive touch sensing mode.

16. The sensor apparatus according to claim 11, wherein the second set of electrodes are shaped so as to surround peripheries of respective electrodes of the first set of electrodes; and
wherein the first and second sets of electrodes are electrically separated from each other.

17. The sensor apparatus according to claim 11, wherein each of the second set of electrodes has a first connection to a processing system, a first half, a second half, a second connection to the processing system;
wherein the first and second connections to the processing system for a respective electrode of the second set of electrodes are disposed on a first side of the respective electrode;
wherein the first half and the second half are electrically connected to each other on a second side of the respective electrode opposite the first side; and
wherein the current loop traverses the first connection to the processing system, the first half, the second half, and the second connection to the processing system in sequence.

18. The sensor apparatus according to claim 17, wherein a portion of a respective electrode of the second set of electrodes corresponding to a respective sensing pixel comprises four parts, wherein two of the four parts are part of the first half and are connected to each other via a first jumper that bypasses a respective first electrode, and the other two of the four parts are part of the second half and connected to each other via a second jumper that bypasses the respective first electrode.

19. The sensor apparatus according to claim 11, wherein the single integrated layer is a metal mesh layer, and each of the plurality of electrodes is comprised of metal mesh.

20. A method for performing stylus sensing and capacitive touch sensing using an integrated stylus and capacitive touch sensing layer, comprising:
performing, by a processing system, stylus sensing using the integrated sensing layer;
detecting, by the processing system, a location of a stylus in a sensing region of a touch sensor device based on the stylus sensing;
performing, by the processing system, capacitive touch sensing using the integrated sensing layer; and
detecting, by the processing system, a location of an input object in the sensing region based on the capacitive touch sensing;
wherein the integrated sensing layer comprises a first plurality of electrodes and a second plurality electrodes, wherein the second plurality of electrodes is configured to be used as current loops for stylus sensing while performing the stylus sensing and as transmitter or receiver electrodes while performing the capacitive touch sensing, wherein the first plurality of electrodes is configured to be used as transmitter or receiver electrodes or as ground or guard electrodes while performing the capacitive touch sensing, and wherein the first and second pluralities of electrodes are disposed on a same layer of the touch sensor device.
